(19) United States
(12) Patent Application Publication
(10) Pub. No.: US 2011/0057034 A1
(43) Pub. Date: Mar. 10, 2011

(54) SECURE TRANSACTION DEVICE AND SYSTEM

(76) Inventor: Leonard Maxwell, Coventry (GB)

(21) Appl. No.: 12/810,963

(22) PCT Filed: Dec. 9, 2008
(86) PCT No.: PCT/GB2008/004047

§ 371 Date: Aug. 10, 2010

(30) Foreign Application Priority Data
Dec. 28, 2007 (GB) 0725277.8
Mar. 1, 2008 (GB) 0803893.7

(51) Int. Cl. G06K 5/00; G06F 7/10

(52) U.S. Cl. 235/382

(57) ABSTRACT

A portable transaction-enabling device (10), said device comprising: one or more first card receiving formations therein for storage of one or more cards within the device; a second card receiving formation (24); a reader associated with said second formation and arranged for reading data stored on a card (26) within said second formation; signal transmission means arranged for transmission of a verification data signal upon verification of card data read by said reader; and a data transfer member. The data transfer member comprises a second memory. The second memory is in electronic communication with said reader such that data read from the card when inserted in said second formation is transmitted to said second memory for access by an external device so as to allow indirect access to data stored on said bank card (26) for processing of a transaction via said data transfer means.

The present invention relates to a secure transaction system and more specifically to a system in which transaction data is provided using a user device.

There is growing concern over identity theft and the fraudulent use of personal details for the purchasing of goods or services. The introduction of microchip-based bank cards or smartcards has drawn attention to the need for increased security at the point of purchase in, for example, a retail environment or else at a cash point. However the secure use of a bank card at a public user terminal represents only part of the problem faced by consumers.

A significant and increasing percentage of purchases are made online via merchant web sites. The security of online transactions is of growing concern to consumers and is inhibiting a more widespread uptake of online purchasing despite the benefits it carries for both consumers and businesses. At present a user is typically required to enter bank account details via a merchant web site, which details are used to send a transaction request to the user's bank. The frequent and repeated input of user bank details provides an opportunity for thieves to obtain personal bank details using Spyware, Trojan Horse programs or else by intercepting the relevant data signals.

In addition there is an increasing problem of bogus web sites established to dupe a user into entering personal details in the belief that they are purchasing products or services. Instead the hosts of those web sites gather personal details in order to allow them to conduct transactions using the user's bank account details.

One known solution to this problem involves the use of a portable electronic device which is carried by the user. The device has a card reader such that the user is required to input their card into the card reader prior to making a transaction. The electronic device generates a code which the user must input and send to the bank before initiating the transaction. The bank then returns two independent security codes to the user who is required to enter elements of each code which make up a final security code required by the bank before the transaction can proceed.

Whilst this does offer one method for increasing security of online transactions, it has been found to be immensely unpopular with consumers due to the complexity of the procedure. The reality of this system is that it is more likely to discourage than encourage further use of online purchasing.

Known systems also require a user to carry a portable electronic device with them which is dedicated to transaction security. Given that it is not uncommon for individuals to carry other portable devices with them, such as mobile telephones, PDAs and the like, the need to carry a further portable electronic device for transactions also represents an inconvenience to a potential user.

It is an object of the present invention to provide a transaction system and an associated user apparatus which offers a high level of security with minimal inconvenience to the user.

According to a first aspect of the present invention there is provided a portable electronic device for use in conducting a transaction, the device being shaped for reception of a user's bank card and comprising a reader for reading data stored on the bank card; biometric scanning means for scanning one or more biometric characteristics of a user; storage means for storing scanned data within the portable device; processing means for comparison of a scanned biometric characteristic with biometric data stored on said device; and, signal transmission means, wherein the device is arranged to enable transmission of a verification data signal via said transmission means upon determination of a match between scanned biometric data and biometric data stored on said device for bank card data read by said reader.

The device allows a user to verify their identity locally such that it is not necessary to transmit the biometric data itself to a bank or merchant. Instead the verification signal may simply provide confirmation that the scanned biometric data corresponds to the card data read by the reader. Typically the verification signal is encrypted.

In one preferred embodiment the biometric scanning means comprises fingerprint scanning means such as a fingerprint module. Thus a user can simply touch or swipe one or more digits over the scanning means in order to verify their identity.

The storage means may be one-time programmable and may comprise a fusing non-volatile memory. Thus once the biometric data is first captured or recorded, the memory fuses so that the stored biometric data cannot be rewritten and is extremely difficult to reverse engineer.

The present invention requires a user's biometric data to match both the stored data and also the corresponding bank card data before a transaction can commence. The combination of these three requirements provide for a transaction system having a high level of security.

In one embodiment, the transmission means comprises wireless data signal transmission means. Additionally or alternatively, the device may comprise connection means for connecting the device to a PC, laptop, palmtop or other device capable of connection to a network. Thus the portable device may be connected to the internet via a server, wireless router or other conventional network connection means.

In one embodiment, the portable device is shaped to provide a card slot such that a portion of the card is enclosed within said slot during use. Preferably the slot is shaped such that a portion of the card protrudes beyond the slot during use. The slot may have an end or stop formation such that the length of the slot is less than half the length of the card. In this embodiment, the portable device may be useable at the same time as a conventional card reader such as those provided in retail environments or the like. The portion of the card protruding beyond the portable device may be insertable into the card slot in a conventional card reader.

The device may comprise display means in the form of a display screen for the display of any or any combination of a string, security code, numbers and/or instructions to the user. In one embodiment the device comprises a key pad for data input by a user.

In one embodiment, the device may take the form of a portable communications device such as a mobile telephone or cell phone. The card reader, card slot and fingerprint module may supplement the normal functions and components of a conventional mobile telephone along with the programming of the mobile telephone in order to provide a device in accordance with the present invention. Such an embodiment is advantageous since it may avoid the necessity for a user to carry multiple electronic devices with them at any one time.

According to one preferred embodiment, the device may be housed within a portable storage device, such as a wallet. The electronic device may be generally planar in form. The wallet may have one or more formations for holding one or more cards therein such that a user can select a card from the wallet and insert it into the card slot of the electronic device.

The provision of an electronic transaction device which is integral or else attached to a wallet is particularly advantageous since it allows a user to carry all relevant transaction articles in one storage device.

The electronic device will typically have a protrusion or projection which corresponds to the size and shape of a credit or debit card. The protrusion may be attached to the device by a flexible printed circuit board. The protrusion will typically have a chip located therein and in electronic communication with the card reader in the electronic device such that data stored on a card chip can be read and provided to said protrusion chip during use of the device.

A card which is inserted in the electronic device can be used for a purchase using a conventional card transaction device via the protrusion. Accordingly the protrusion can be inserted into the card transaction device in place of the card within the card slot of the electronic device. Thus the protrusion acts as a ‘dummy’ credit or debit card, through which a user's card details can be supplied to a card transaction device.

According to a second aspect of the present invention there is provided a portable transaction device, said device having one or more first card receiving formations therein for storage of one or more cards within the device; a second card receiving formation; a reader associated with said second formation and arranged for reading data stored on a bank card within said second formation; signal transmission means arranged for transmission of a verification data signal upon verification of card data for a card read by said reader; and, a data transfer member, the data transfer means comprising a second memory, wherein the second memory is in electronic communication with said reader such that data read from a bank card when inserted in said second formation is transmitted to said second memory for access by an external device so as to allow indirect access to data stored on said bank card for processing of a transaction via said data transfer means.

According to a third aspect of the present invention there is provided a system for conducting a transaction between a user and a third party via a financial service provider, the system comprising a portable electronic device for operation by a user, the device being arranged to read data stored on a bank card belonging to the user and to verify the identity of the user by scanning one or more biometric characteristics of a user and comparing the scanned biometric characteristic with biometric data for the user stored on said device; the device being arranged to transmit a verification data signal to said financial service provider upon determination of a match between scanned biometric data and the biometric data stored on said device; wherein the financial service provider comprises transmission means arranged to return a data signal to said device upon receipt of said verification data signal, said return data signal comprising a user code for enabling an ensuing transaction by said user.

The verification data signal may be sent directly or indirectly to the financial service provider. In one embodiment the user code comprises a string of three or more characters or digits. The user code may be use and or time limited. In one embodiment the code is limited such that it is valid for a single transaction only. Thus if another individual is somehow able to obtain the users card and transaction code after the user has been verified by the bank, the card and code can only be used once before the card will be useless without further verification of the user's biometric data.

The system according to the present invention is particularly advantageous since the financial service provider generates the code for the transaction and thus has the code available to verify the correct code input by the user. This code may be a substitute for the three digit security code input by a user during a conventional transaction, such as the three digit code found on the reverse of a credit or debit card. Thus the present invention is simple to implement in that it requires little or no change for merchants or other vendors.

Typically the verification signal varies over time such that a single verification signal is only accepted for one or a limited number of transaction requests.

According to a further aspect of the present invention there is provided a method of conducting a transaction between a user and a third party via a financial service provider, the method comprising: the user operating a portable electronic device to verify the identity of the user by scanning one or more biometric characteristics of the user and comparing the scanned biometric characteristic with biometric data for the user stored on said device; the device being arranged to receive a bank card and to verify said biometric characteristics against data stored for said bank card; transmitting a verification data signal to said financial service provider upon determination of a match between scanned biometric data and the biometric data stored on said device; wherein the financial service provider returns a data signal to said device upon receipt of said verification data signal, said return data signal comprising a user code for enabling an ensuing transaction by said user; the user entering said user code in order to request a transaction with said third party via said financial service provider; and the financial service provider checking said user code against the code provided by way of said return data signal prior to authorizing said requested transaction.

Typically the financial service provider will block the transaction if the user code does not match the code sent by way of said return signal.

Preferred embodiments of the present invention will now be described with reference to the accompanying drawings, of which:

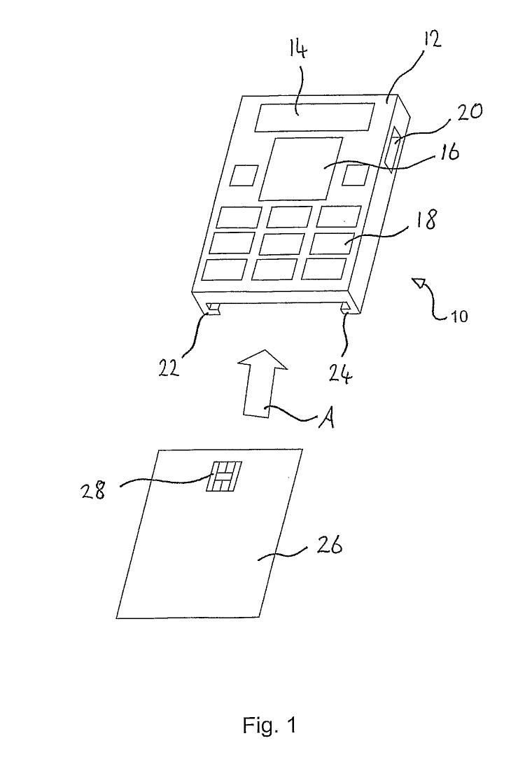

FIG. 1 shows a three-dimensional view of a portable electronic device according to one embodiment of the present invention;

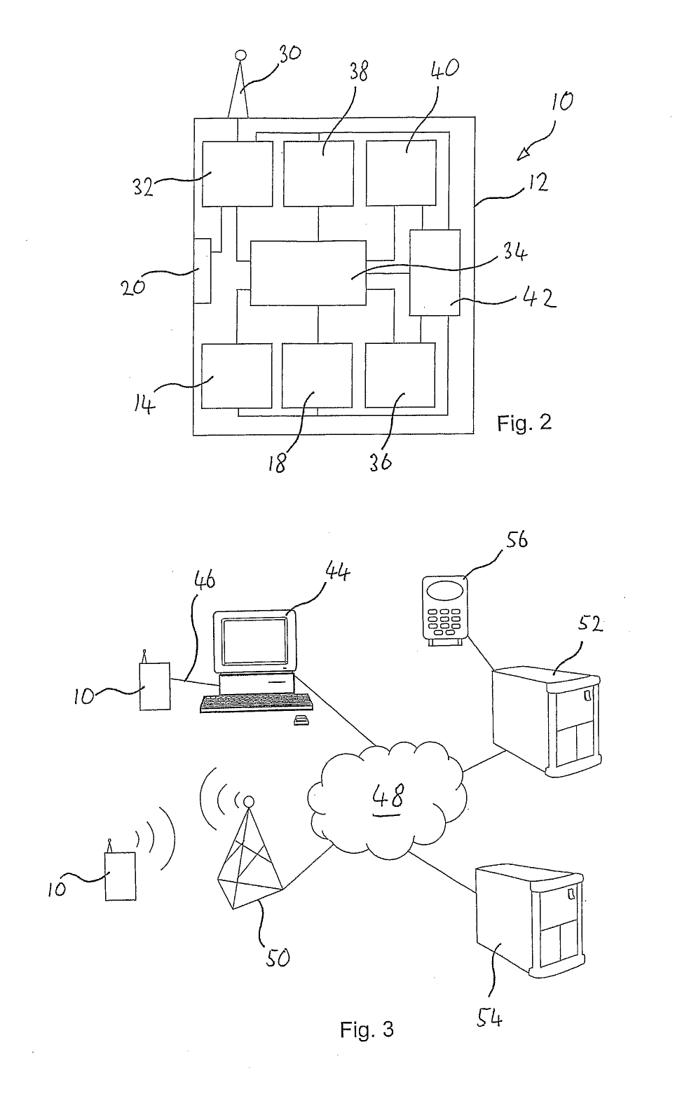

FIG. 2 shows a schematic of the basic electronic components of the device of FIG. 1;

FIG. 3 shows a schematic of the network components for use in accordance with one embodiment of a system according to the present invention;

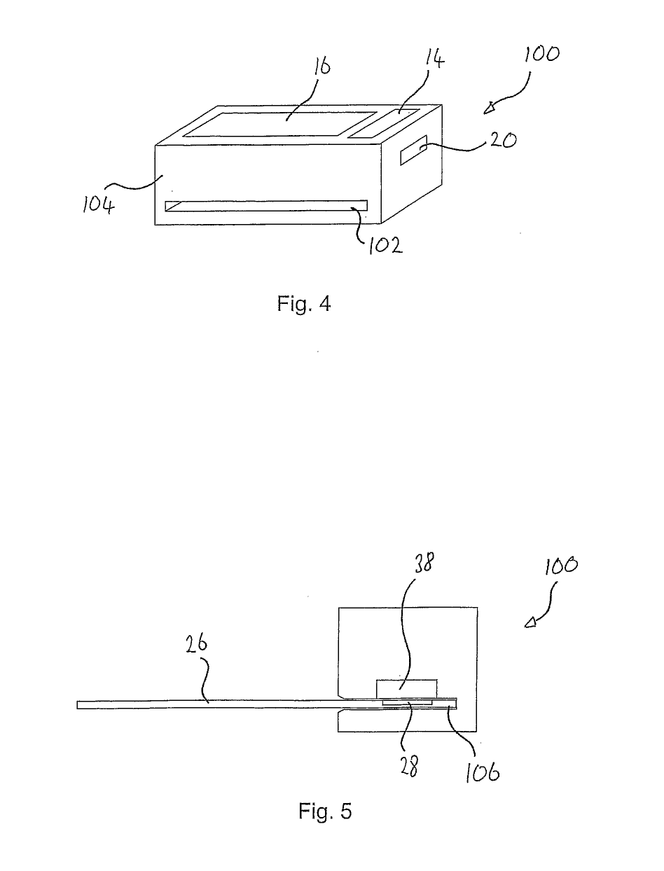

FIG. 4 shows a three-dimensional view of a portable device according to a second embodiment of the present invention;

FIG. 5 shows a cross-sectional view of the device of FIG. 4 in use;

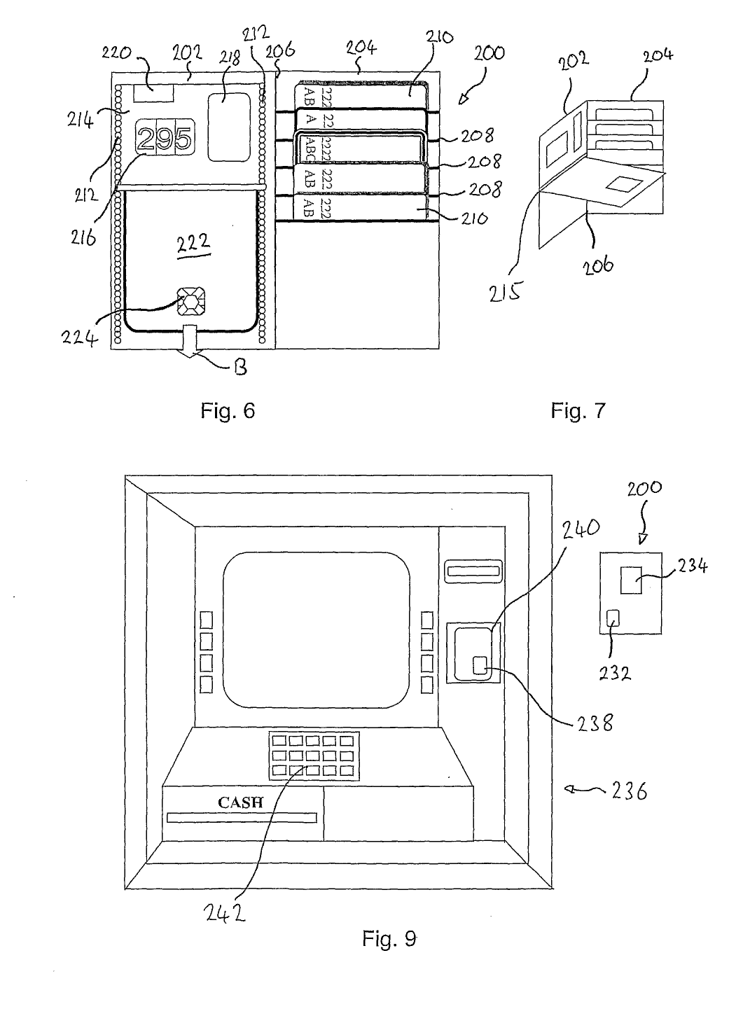

FIG. 6 shows a plan view of a portable device according to a third embodiment of the present invention;

FIG. 7 shows a three-dimensional view of the device of FIG. 6;

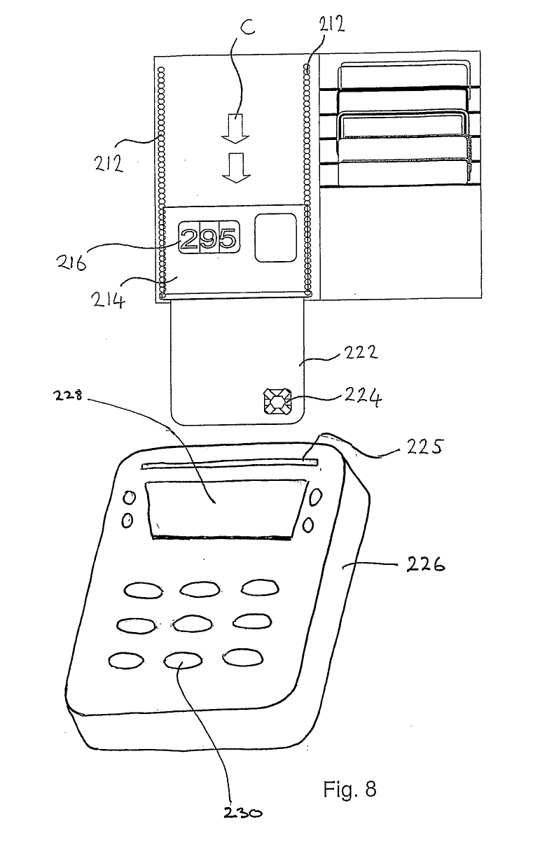

FIG. 8 shows a three-dimensional view of the device of FIG. 6 in use; and,

FIG. 9 shows a view of a further embodiment of the present invention arranged for use with an Automated Teller Machine (ATM).

Turning firstly to FIG. 1 there is shown a portable device 10 which can be used in conjunction with the present invention. The present invention is particularly suited to use by a consumer when purchasing goods or services from a merchant or other business using a bank card either remotely, over a network, or else at a point of sale terminal.

The device 10 comprises a main body or housing 12 having one or more exterior surfaces, on which are mounted a display screen 14, a fingerprint contact surface 16 and a plurality of user keys or buttons 18. The display screen 14 may comprise a liquid crystal display screen or else any other form of electrically powered display capable of showing variable strings of letters and/or numbers. A number of variants of such display screens are available as would be readily understood by the person skilled in the art.

The fingerprint a contact surface 16 forms part of a fingerprint module (see FIG. 3), which also comprises sensing means for determining the temperature differential between the ridges of a user's fingerprint and the air trapped in the intervening valleys. This pattern is converted to an electrical signal by a pyro-electric material, typically in the form of a pyro-electric layer, which is captured by a CMOS chip.

This type of fingerprint sensor is particularly apt for use in the device according to the present invention due to its robustness to applied stress, its small size and minimal power requirements. Whilst a fingerprint module is preferred, it will be appreciate that modules for scanning other biometric characteristics could be used, such as, for example a retina scan module, voice recognition or other physical biometric characteristics.

The user input keys 18 typically take the form of a series of keys numbered 0-9 similar to the keys of a mobile telephone or cell phone. The keys are also typically marked with letters such that a user can input strings of numbers and/or letters into the device in a conventional manner.

The device 10 also comprises a connector port 20 which may comprise a USB connector port or other conventional design so as to allow communication with another electrical device via a cable (not shown). The port 20 may be provided in a side wall of the device or any other suitable surface of the housing 12.

The display 12, fingerprint contact surface 16 and keys 18 are typically provided in one surface of the housing 12. On an opposing side of the device, there are provided retaining formations 22 and 24 suitable for reception of a bank card 26 during use. The bank card 26 has a microchip 28 mounted thereon, on which is contained data relating to the card owner and/or his or her bank account. The card 26 thus takes the form of a conventional smartcard or ‘chip and pin’ card as will be readily understood.

The retaining formations 22 and 24 take the form of opposing walls or bracket-like formations which are spaced so as to allow a card to be inserted therebetween. In this embodiment, the retaining formations are L-shaped in plan so as to provide an elongate lip structure which faces the opposing lip structure of the other retaining formation. Thus a card can be inserted in a longitudinal direction (see arrow A) between the retaining formations and is loosely held against the housing 12 by the opposing lip formations for reading the data stored on the chip 28.

Such a retaining formation is found to be beneficial since it does not encroach on the magnetic strip or signature panel conventionally found on the reverse of a bank card.

Turning now to FIG. 2, there is shown a schematic of the basic electrical components of the device 10, mounted within the housing 12. The components are typically mounted on a printed circuit board or else connected thereto and comprise an antenna 30 which may be internally or externally mounted.

The device 10 comprises signal transmission and reception means which typically takes the form of a conventional transmitter-receiver or transceiver module 32. The transceiver module 32 may be capable of receiving electronic and or radio signals. In a preferred embodiment, the device 10 is capable of receiving data signals via connector port 20 or else wireless data signals via the antenna 30.

Processing means in the form of a processor or microcontroller 34 is connected to the other electronic components. In this embodiment, the processor 34 comprises an integrated circuit having a CPU, RAM and ROM, although it will be appreciated that a separate non-volatile memory may also be provided. The processor has a memory for the execution of programs and communications buffers for sending and receiving data and may take the form of a conventional programmable chip.

The processor 34 is multifunctional, providing USB interface processing, fingerprint biometrics processing, user input and signal data processing.

The fingerprint module 36, the display module 14 and the user input keys 18 are all connected to processor 34.

A reader component comprises a card reader module 38 which may contact the card chip 28 so as to supply the chip with electricity and thereby enable reading of data stored on the chip according to standard constructional and communications protocols. Although currently less popular for smart cards, the system may also operate based upon contactless apparatus using RFID tags and reading apparatus. RFID tags may or may not comprise integrated circuitry.

A separate read only memory is provided at 40 which comprises a secure one time programmable, fuseable non-volatile memory. Such fuse memory devices typically have an array of fuse elements as well as a control circuit for providing secure access to the stored data within, wherein the secure data is inaccessible from within the fuse memory device without proper control circuit operation and secure access verification. Such memory devices have been found to store data in a secure manner which is extremely difficult to access by third parties.

The electrical components are powered by a power supply 42 in the form of a single-use or rechargeable battery unit 42. In one or more other embodiments, the unit may be powered via USB port 20.

In order to use the portable device 10, a user will be required to insert their bank card such that it can be recognised by the reader 38 and then enter a plurality of finger prints using the finger print module 36. A user may be required to enter a print for all ten digits in turn when prompted by instructions on the display screen 14. It will be appreciated that reference to finger prints within the present application is intended to encompass both finger and thumb prints alike.

During this initial scan, the fingerprints are scanned in three dimensions and then digitised for storage on the memory device 40. The stored digitised data represents the minutia derived from the ridges and troughs in the fingertip, for which various open source algorithms are available. When a suitable number of fingerprints have been stored, the memory device 40 fuses such that the fingerprint data cannot be overwritten and further fingerprint data cannot be stored. Access to the fingerprint data other than by way of the programmed activity of the processor 34 is prohibited.

The user's fingerprints may be registered under guidance of the user's financial service provider, for example at the user's branch of a bank. The user's personal details may be entered whilst the device is connected to a PC via port 20. In addition one or more cards may be inserted into the card slot and registered for use in conjunction with the device. The device may provide an audible or visible signal to confirm when each finger print and/or card has been registered by the device.

In an alternative embodiment, the financial service provider may send the device to a user for registration. The device will not become fully functional for entry of their fingerprints until the user has completed a set of registration steps, such as the input of their PIN number for the or each bank card or else the verification of certain personal data. The device may be required to be connected to a PC for accessing a secure web site or portal of the financial service provider in order to complete such registration steps. The device may comprise a timer for timing the registration procedure. In the event that the registration procedure exceeds a predetermined time limit, the device may inhibit further use.

Once the data has been stored and the user's card removed, further reinsertion of the card 26 will cause the device to prompt the user to press or swipe one or more fingers in turn on the contact surface 16. Thus the device can scan the fingerprint and compare the scanned data with the stored fingerprint data. In the event of a match, the device will validate the identity of the user and proceed with steps in accordance with the method and system of the invention as described in relation to FIG. 3 below.

In one embodiment, the portable device 10 may take the form of a mobile telephone or other portable communications device such as a PDA, palmtop, pager or the like. In such an embodiment, the device will typically comprise a GSM telecommunication set or module which may be a self-contained module similar to or the same as those used in conventional mobile telephones. The open standards allow interoperability with mobile telephone networks. Such a device will typically provide GPRS data transfer, SMS messaging, TCP/IP connections as well as standard and hands-free voice communication. Accordingly it will be appreciated that the device will likely comprise additional hardware such as a speaker and microphone to enable voice calls.

The GSM thus allows data to be transferred to and from the device for use in verifying the identity of a user.

Any embodiment of the present invention may comprise a solar panel strip by way of an additional or alternative additional power source to the battery 42.

The provision of the functionality of the present invention in combination with a multi-function portable communications device is particularly beneficial since it avoids the inconvenience of carrying multiple devices at any one time. However in an alternative embodiment, the device may be attachable to a portable communications device via a connector such as a cable, for example via USB port 20. Thus the device may make use of the telephone connectivity to a wireless network for transmission and reception of transaction data. In such an embodiment, the portable communications device, such as a portable telephone may have software thereon which enters a transaction processing routine as soon as connection with the device 10 is detected.

Turning now to FIG. 3, there is shown the basic components of a system according to the present invention. It will be appreciated that the system of FIG. 3 represents a simplified version of an actual operational system.

Two embodiments are shown in FIG. 3, one in which the device 10 is connected to another piece of hardware such as a user's home PC or laptop 44 via cable 46, which may be a USB cable. The PC 44 provides connectivity to the internet 48 or any other suitable network and manages data transfer between the device 10 and any other parties involved in the transaction. It will be appreciated that the device 10 in this embodiment may also communicate with the PC 44 using wireless communication protocols such as WiFi® or Bluetooth® or any other wireless system capable of carrying data signals. When connected certain transaction or verification steps may be carried out by a user via the PC running one or more relevant routines or else using the keypad 18 on the device.

In the second embodiment, the device 10 communicates with a base station 50 to allow connection to the relevant network 48. It will be appreciated that the base station will typically be connected to an operation and support station or else other stations in order to enable the desired communications. However the operation of such communication networks are well documented and further explanation is omitted here for conciseness.

For either a wireless or a wired operational setup, the network will typically involve one or more merchants having hardware capable of communication with the network 48, indicated in FIG. 3 by server 52. The user's fininancial service provider, which will typically be a bank, also has hardware capable of communication with the network 48, indicated in FIG. 3 by server 54. It will be appreciated that the electrical equipment provided at each of the merchant and the bank will typically exceed the servers 52 and 54 shown and each of the merchant and bank will typically maintain a plurality of further computers or other electronic devices connected to a local network.

The steps involved in one mode of operation of the system shown in FIG. 3 are described below:

Prior to conducting a transaction, the user validates their identity and card details using device 10 as described above by inserting the relevant card and swiping one or more fingers or thumbs on contact surface 16.

Upon validation of the user's card and fingerprint, the device 10 transmits an encrypted validation signal to the bank server 54 over network 48. The signal may be sent via communication device 44 or base station 50 dependent on the connectivity of the device 10. The network destination or address of the bank is typically pre-programmed in to the device 10 such that the validation message can be sent automatically. In one embodiment the device 10 initiates a call or message transmission which is answered by the bank.

The validation signal comprises coded validation data in the form of one or more data packets which are recognisable to the bank and which identifies that the user has transmitted a valid transaction request. In addition the validation data packet or message will typically identify the user and the network address from which the transaction request was sent.

The bank then generates a security code for the user. The bank stores the security code against the user's record held by the bank and also transmits the security code to the user's device 10 by way of an encoded data message. Upon generation of the security code, the bank may also log the time at which the code was created and/or transmitted to the user's device. The bank may also store a predetermined time limit for which the security code is valid. The security code itself will typically comprise a string of three or more digits.

Upon receipt of the return message from the bank, the user device 10 decodes the message and displays the security code on screen 14. The device may also alert the user of the receipt of the code by a visual, auditory or tactile alert, such as a buzzer, bleep, a flashing screen 14 or else by vibration of the device 10.

The user can now conduct the desired transaction with the merchant by completing the necessary details in a purchase request, such as on a web site or other page accessible over the network 48. One example of the data required for input by the user is given in Table 1 below:

TABLE 1

| Card Type: | Switch/Delta/Electron |
|---|---|
| Name on Card: | Joe Bloggs |
| Card Number: | 000000101 |
| Start Date (mm/yy) | 12/05 |
| Expiry Date (mm/yy) | 12/09 |
| CVV/security number: | 000 |
| Issue number: | 5 |

It will be appreciated that a significant number of merchants and/or banks already require a security number to be input as indicated in table 1 above in order to complete a transaction. This number is conventionally provided on the users bank card. However according to one embodiment of the present invention, the security code provided by the bank can replace this conventional security code.

The merchant or other business then transmits the data input by the user to the bank server 54 in order to process the requested transaction. The bank can check the security code provided against the security code issued to the user along with the other input user data. The bank can then process the transaction if a match is determined or else refuse the transaction if the submitted security code does not match the security code currently stored for that user.

Once the bank has received the matching security code for the processing of the transaction, the security code stored by the bank will be deleted or else stored as an expired code. Thus the security code may be valid for a single transaction only. Additionally or else alternatively, the bank may allow the code to be used for a predetermined number of transactions. Additionally or else alternatively the security code may be time-limited such that the validity of the security code expires after an hour or else a day. Thus the user may use the code for any number of transactions over the predetermined time period or else may use the security code only a predetermined number of times over that time period.

Once the security code has expired, the user is required to initiate another transaction request to the bank by validating their identity using the portable device 10 as described above.

It will be appreciated that a number of merchants have available so-called chip and pin card machines available within retail environments. Such a card reader is shown in FIG. 3 at 56. In order to enable use of the present invention in store, the card reader 56 must merely be programmed to prompt the user to input a security code in addition to their PIN number as part of the transaction request. This represents only a minor software change to existing card readers and is thus easily implemented with minimal disruption to the merchant's business.

Thus a user can request a security code from the bank as described above and then conduct a secure transaction using a vendor's card reader. Upon reading the data on the card chip 28, the card reader 56 may determine whether a security code is required to be input for that card. Accordingly, the data stored on the card chip 28 may simply comprise an additional piece of data indicating that the card requires a security code to be entered in accordance with the present invention before a transaction can proceed.

A further embodiment of the user's portable device is shown in FIGS. 4 and 5 at 100. The features and operation of the device 100 is the same as that described for the device 10 in FIGS. 1 and 2 save for the following differences:

The device 100 omits the user keys 18 of FIG. 1 and instead is automatically activated upon insertion of a card into slot 102. Thus the device is dormant until a card is sensed within slot 102. The sensor may comprise a simple switch-like means which is displaced by insertion of the card. The detection of the presence of a card in any embodiment can trigger the device to operate a predetermined program for user ID validation.

The opposing formations 22 and 24 of FIG. 1 have been replaced by a slot 102 or cut-out in the device housing 104 which defines an entrance to an internal cavity 106 (see FIG. 5) shaped to receive card 26.

The dimensions of the device 100 and cavity are reduced compares to device 10 such that only a section of the card is insertable into the cavity as shown in FIG. 5. Typically only the end of the card comprising the chip 28 is required to be enclosed within the cavity 106 to ensure the correct positioning of the chip 28 relative to the reader module 38 for reading the card data.

The entrance to the slot 102 may be tapered for ease of insertion of the card.

Once the card has been inserted the user is prompted to validate their ID by inputting one or more fingerprints as described above. The validation message can be sent to the bank automatically upon verification of the user's ID. The returned security code may be displayed on screen for as long as the presence of card 26 is detected within slot 102 or else for a predetermined time. However there may be provided a button to allow a user to recall the security code on screen at a later time.

This embodiment is advantageous since a significant portion of the card 26 is not enclosed by the device 100 in use and is thus free to be inserted into another conventional card reader such as that shown at 56 in FIG. 3. Thus the user can commence a transaction using card reader 56 whilst the other end of the card is located in the portable device 100. In this embodiment the display screen 14 can display the security code for input by the use whilst operating the card reader 56. Such an embodiment may require the card 26 to have two chips 28 located thereon, one at each end of the card so as to allow simultaneous processing of the card data using two separate card reading devices.

If the user has forgotten the security code, they can simply repeat the validation procedure in order to obtain a new code which will replace the previous code issued by the bank.

It will be appreciated that there exist a number of payment service providers which store a user's personal and bank account data such that a user is not required to re-enter that data every time a purchase is made. The present invention can be used in conjunction with such services merely by requiring the user to enter the security number described above in order to complete a transaction request. In any such embodiment, the transmission of the security code for the user may be conducted separately from a signal which contains the user's bank or personal details. This is of significant benefit to the security of the system since the interception of any one of these signals alone would not provide sufficient information to allow fraudulent use of the user's bank account.

An alternative embodiment to that of FIGS. 4 and 5 is shown in FIGS. 6 to 8. In this embodiment, the electronic transaction device is integrated with a wallet or other card storage device 200. In the embodiment shown in FIG. 6, the combined card storage and transaction device 200 is shown in an open condition and comprises a pair of opposing portions 202 and 204. The opposing portions are joined along a central joining line 206 or portion which takes the form of a spine.

The card storage device can be opened or closed by folding the opposing sides 202, 204 of the wallet about the centreline or spine 206 such that the contents of the wallet can be exposed or concealed as required.

The first portion 204 has card receiving formations or slots 208 therein such that one or more bank cards 210 can be inserted and removably retained within the slots 208 for storage of the cards.

On the opposing face of the second portion 202, electronic transaction means are provided. In this embodiment the electronic transaction means are substantially as described in FIGS. 1 to 5 above. However in this embodiment the electronic device 214 is formed as a substantially planar article which is attached to the second portion 202. In this regard, the electronic transaction device 214 may be enclosed within a pocket or pouch or else may be clipped or otherwise fastened to retaining formations 212 on the wallet 200. In another embodiment, the electronic device may be fastened to the wallet using other conventional fastening means such as one or more straps or else by way of an adhesive such as a glue.

The device 214 has a display 216 capable of displaying three or more digits, a finger/thumb print sensor 218, a port 220 and a card reader slot (not shown) such that it can be used in a manner as described above in relation to FIGS. 1 to 5.

The embodiment of FIG. 6 also comprises a data transfer member in the form of an extension member or projection 222, which is electrically connected to the device 214. In particular the projection 222 comprises a chip 224, which is electrically connected to a card reader (38 in FIG. 2) within the body of device 214. The projection 222 is the size and shape of at least part of a card, such as a credit or debit card, such that the projection 222 can be used as a ‘dummy’ card for the purpose of carrying out a transaction as will be described in further detail below. The projection is typically the size and shape of at least half of a bank card.

In one embodiment, the card-like projection 222 is movably connected to the body of the device 214. The projection may be hingedly connected to the device 214, for example by way of a flexible printed circuit board or else by an electrically conductive hinge connector. In such an embodiment, the connection between the projection 222 and the device 214 allows the projection to be rotated relative to the first wallet portion 202 between a first condition in which it is substantially flat against the first wallet portion 202 and a second condition, in which the card is oriented obliquely thereto as shown in FIG. 7. In FIG. 7 a hinge formation between the projection 222 and the body of the device 214 is shown at 215.

In an alternative embodiment, the retaining formations 212 take the form of opposing runners or rails, each having a slot therein such that the body of the device 214 is held within the opposing slots. In this embodiment the body of the device may have a flange or similar formation along opposing edges thereof for engagement within the rails 212. The device 214 may be slid between a storage condition, in which the body of the device 214 and the protrusion 222 are retained substantially within the perimeter of the wallet as shown in FIG. 6, and an in-use condition, in which the protrusion extends beyond the perimeter of the wallet, as shown in FIG. 8. The body of the device 214 is movable between the storage and in-use conditions by sliding the device along the rails 212 in a linear fashion in the direction of arrow B.

In the embodiments of FIGS. 6 to 8, the electronic components and the functionality of the device 214 is substantially as described above in relation to FIGS. 1 to 5. However the embodiments of FIGS. 6 to 8 also provides for use in conjunction with a conventional card transaction machine in a more convenient manner.

When a user desires to use the device of FIGS. 6 to 8, the user first selects a credit or debit card 210 which they wish to use from the cards stored in the wallet 200. The user then inserts the card into the card slot within the body of the device 214 in the direction of arrow C in FIG. 8. The user is then required to swipe their finger or thumb across the sensor 218 in a manner as described above in order to verify their identity to the device 214. The relevant card details are read by the reader within the device 214 and compared to the details stored within the device for that user. Upon validation of the user's identity and the card details, the device transmits a verification signal in order to request a return data signal from the user's bank or other financial service provider. When the return signal is received, the security code contained within the return signal is displayed in the display 216.

The card data read by the reader is transmitted by the device to the chip 224 on protrusion 222. Thus the protrusion can be inserted in a card slot 225 in a conventional card transaction machine 226, whilst the user's bank card 210 remains within the device 214. A user can thus carry out a transaction in a normal manner.

However, before sending the transaction request to the financial service provider, the transaction machine 226 provides a user prompt on display screen 228 which prompts the user to enter the transaction security code. The user then enters the security code into the transaction machine 226 using keys 230. Once this has been entered, the transaction machine sends the transaction request including the user entered security code to the user's financial service provider. The financial service provider can then verify the user's bank details as well as the security code against the security code previously sent to the user's device 214. Upon verification of the details, the transaction will be authorised.

This process adds additional security to a user transaction conducted using, for example, a debit or credit card, with minimal disruption to the user or merchant. The security code may be valid for a single transaction, or else for a predetermined number of transactions, or else may remain valid until a request to change the security number is instigated by the user via the device.

In the event that an incorrect security code is entered by the user or else an unrecognised finger/thumb print is entered, the device may run one or more routines to establish whether an unauthorised user is attempting to use the device in a fraudulent manner. The device may prompt the user to validate one or more finger/thumb prints or input one or more security codes. In the event that fraudulent use of the card is determined, for example by input of two or more incorrect codes or unrecognised finger/thumb prints, a further routine may be triggered whereby the device send a signal to the financial service provider.

However the device will continue to operate in a manner which appears to the user to be the same as a normal transaction routine. In such an instance the financial service provider may send a code indicative of fraudulent use to the device in the form of a security code. When an unsuspecting user inputs the code, believing it to be a normal security code, it may trigger an automated routine within the transaction terminal being used. Such a routine may involve the trigger of an alarm or else an alert signal to the authorities containing details of the fraudulent use, such as time, date, location and details of the card and/or transaction machine being used in a fraudulent manner. Thus the authorities or any other institutions can be alerted without the knowledge of the user.

A further embodiment of the present invention will now be described in relation to FIG. 9. In this embodiment, the user device further comprises near-field wireless identification means, such as a radio frequency identification (RFID) tag or infra-red receiver 232 for use of a transaction machine such as for example an ATM. In such an embodiment, the ATM comprises an associated near field scanner or reader. The ATM may also comprise indicia 240, indicating to the user a suitable location for positioning of their device for reading by the ATM.

The wireless identification means will typically be mounted in the device 214 and connected to the card reader in the device.

When using a device according to this embodiment for accessing an ATM, the user will first insert their card 210 into the device 214 such that the card details can be read. The user will then position the device against the relevant portion of the ATM machine adjacent the scanning means 238 such that the relevant card and/or user data can be read by the ATM 236. This is typically achieved by holding up the wallet 200 to the appropriate portion of the ATM.

The wallet 200 and/or device 214 may have retaining means such as a magnet or else a magnetic member 234 mounted therein such that the use can position the device as required which will be removably held against the ATM by a corresponding magnet or magnetic member on the ATM in the vicinity of the scanner 238.

The user scans one or more fingers/thumbs such that they can validate their identity to the device, which triggers a validation signal transmission to the ATM via the near-field identification means. The ATM will then contact the relevant server or other facility of the financial service provider in order to request a security code for subsequent use by the user. Once the security code is received it is transmitted to the user's device via the ATM and displayed on screen 216. A use may then remove the device from the ATM and insert the relevant bank card into the ATM to access their account in a normal manner using the user interface.

The ATM will request entry of the security code by the user as part of the required information in order to access the user account or conduct a transaction. Upon verification of the security code, the ATM can issue money from the user account or transfer funds as requested by the user.

The embodiment described above relies on the transmission or scanning or of data between the device and the ATM. Accordingly either the device or the ATM could comprise suitable near field transmission or scanning means. In one embodiment, the ATM provides an energy source, such that contact between the device and the ATM causes the identification means in the device to become energised for transmission or broadcast of data. Typically the range of the identification means is 1-2 metres or less.

Whilst the functionality described in association with FIG. 9 is felt to be particularly suitable to the embodiment of the invention shown in FIGS. 6 to 8, it may equally be applied to the embodiments of FIGS. 1 to 5. Any embodiment may be adapted for use as described in relation to FIG. 9 by provision of the necessary RFID or other type or sensor/transmitter/receiver means.

In an alternative embodiment, the user may simply use the device to request a security code remotely as described in relation to FIGS. 1 to 5. the user may then use that code for accessing their account via an ATM.

The features and functionality of any of the embodiments described above are not exclusive to any one embodiment and are to be considered interchangeable with individual features of one or more other embodiments as far as practicably possible. For example any of the embodiments of FIG. 1, 2, 4 or 5 may be provided as part of a card holder or wallet arrangement as described in relation to FIGS. 6 to 9.

1. A portable transaction-enabling device, said device comprising:
one or more first card receiving formations therein for storage of one or more cards within the device;
a second card receiving formation;
a reader associated with said second formation and arranged for reading data stored on a card within said second formation;
signal transmission means arranged for transmission of a verification data signal upon verification of card data read by said reader; and,
a data transfer member, the data transfer member comprising a second memory,
wherein the second memory is in electronic communication with said reader such that data read from the card when inserted in said second formation is transmitted to said second memory for access by an external device so as to allow indirect access to data stored on said bank card for processing of a transaction via said data transfer means.

2. A portable device according to claim 1, further comprising biometric scanning means.

3. A portable device according to claim 2, wherein the biometric scanning means comprises a fingerprint scanner.

4. A portable device according to claim 1 wherein the device comprises a wallet, within which an electronic transaction device is housed.

5. A portable device according to claim 1 wherein the device comprises a body within which the card receiving formations are formed and wherein the data transfer member is movable relative to said body.

6. A portable device according to claim 1 wherein the data transfer member comprises a projection having a shape which corresponds to the shape of the card, said projection being movable into an in use position in which the projection extends outwardly of said device so as to allow insertion of the projection into a card-receiving machine.

7. A portable device according to claim 1 wherein the device comprises wireless data transmission means.

8. A portable device according to claim 1 wherein the device comprises near field identification means.

9. A portable device according to claim 7, wherein the device comprises a radio frequency identification tag or scanner.

10. A portable device according to claim 1 wherein the portable electronic device comprises connection means for connecting the device to a PC, laptop, palmtop, mobile telephone or other device capable of connection to a network.

11. A portable device according to claim 1 wherein the second card receiving formation removably holds the card in a position suitable for accessing data stored on an integrated circuit on said card.

12. A portable device according to claim 1 wherein the second memory comprises an integrated circuit.

13. A portable device according to clam 1 further comprising display means for displaying a user transaction code to a user.

14. A portable device according to claim 1 wherein the device is arranged to prompt the user to verify their identity and obtain a user transaction code for use in an ensuing transaction using said card.

15. A card storage wallet comprising:
one or more first card receiving formations therein for storage of one or more cards within the device;
a second card receiving formation;
a reader associated with said second formation and arranged for reading data stored on a card within said second formation;
signal transmission means arranged for transmission of a verification data signal upon verification of card data read by said reader; and,
a data transfer member, the data transfer member comprising a second memory, wherein the second memory is in electronic communication with said reader such that data read from the card when inserted in said second formation is transmitted to said second memory for access by an external device so as to allow indirect access to data stored on said bank card for processing of a transaction via said data transfer means.
